(19) United States
(12) Patent Application Publication
(10) Pub. No.: US 2008/0128065 A1
(43) Pub. Date: Jun. 5, 2008

(54) Pneumatic tire with oxygen barrier component comprised of a rubber composition containing a dispersion of oxygen-adsorbing activated carbon

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/606,735

(22) Filed: Nov. 30, 2006

(51) Int. Cl. B60C 5/12

(52) U.S. Cl. 152/510

(57) ABSTRACT

The present invention relates to a pneumatic tire having an oxygen barrier component comprised of a rubber composition which contains a dispersion of oxygen-adsorbing activated carbon. The oxygen barrier component may be an internal or external component of the tire. The oxygen barrier component is intended to retard migration of atmospheric oxygen to internal rubber components within the tire. In one embodiment, the oxygen barrier component may be in a form of one or more of an oxygen barrier rubber layer positioned between a tire carcass ply and a tire inner liner rubber layer, an oxygen barrier rubber layer covering axial outer edges of a circumferential belt ply, an outer tire sidewall oxygen barrier rubber layer and a tire tread

### FIELD OF THE INVENTION

The present invention relates to a pneumatic tire having an oxygen barrier component comprised of a rubber composition which contains a dispersion of oxygen-adsorbing activated carbon. The oxygen barrier component may be an internal or external component of the tire. The oxygen barrier component is intended to retard migration of atmospheric oxygen to internal rubber components within the tire. In one embodiment, the oxygen barrier component may be in a form of one or more of an oxygen barrier rubber layer positioned between a tire carcass ply and a tire inner liner rubber layer, an oxygen barrier rubber layer covering axial outer edges of a circumferential belt ply, an outer tire sidewall oxygen barrier rubber layer and a tire tread

### BACKGROUND OF THE INVENTION

Pneumatic tires often contain internal and external rubber components which may be subject to exposure to atmospheric oxygen, including exposure to atmospheric oxygen which may have migrated into the tire body.

For this invention, it is desired to retard migration of atmospheric oxygen to various components of a pneumatic rubber tire, including internal components, by appropriate positioning of one or more oxygen barrier components.

External tire components are components which are typically visually observable which may include, for example, a tire outer tread (which usually contains the tire's running surface), outer sidewall layer and tire chafer components.

Internal tire components are components which are not typically readily visually observable which may include, for example a tire tread base layer underlying a tire outer tread layer, belt ply rubber layer containing cord reinforcement, carcass ply rubber layers containing cord reinforcement, internal sidewall rubber layers, internal sidewall rubber apex components and internal sidewall rubber stiffening inserts other than said apex components.

Accordingly, in one aspect, an internal oxygen barrier rubber layer may be positioned between a cord reinforced rubber carcass ply and a tire inner liner rubber layer and to thereby be positioned, or located, next to and underlying a pneumatic tire inner liner rubber layer.

In practice, a tire inner liner rubber layer is typically relatively impermeable to air (including oxygen) to thereby inhibit oxygen from migrating from a pneumatic tire's cavity into the tire body such as a tire carcass ply and other tire components.

For such purpose, a pneumatic tire inner liner rubber layer is typically comprised of a butyl rubber-based rubber inner liner layer within the tire cavity designed to inhibit permeation of air, particularly oxygen, from the tire cavity into the tire carcass which is a feature well known to those having skill in such tire art. Such butyl rubber (the term “butyl rubber” is intended herein to include halobutyl rubber such as for example bromobutyl rubber and chlorobutyl rubber, unless otherwise indicated) is typically relatively impermeable to air, including oxygen, and moisture and is often used as a major portion of the tire inner liner composition. For example, see U.S. Pat. No. 3,308,177 as well as U.S. Pat. Nos. 6,390,164 and 6,345,656.

Accordingly, an aspect of the invention is a pneumatic tire having an additional internal oxygen barrier rubber layer next to and underlying such tire inner liner layer (e.g. positioned between the tire inner liner rubber layer and a carcass ply layer) to further inhibit oxygen from migrating to the tire body (e.g. to a tire carcass ply).

Such internal oxygen barrier rubber layer contains a dispersion of an oxygen-adsorbing particulate activated carbon to adsorb such oxygen and to thereby inhibit its migration through such oxygen barrier rubber layer. Such internal oxygen barrier layer may be comprised of, for example, an elastomer comprised of natural cis 1,4-polyisoprene rubber which also contains the oxygen-adsorbing activated carbon dispersion. The pneumatic tire inner liner rubber layer may be comprised of butyl rubber such as, for example, a halobutyl rubber such as for example at least one of bromobutyl rubber and chlorobutyl rubber which may also contain an non-halogenated butyl rubber.

Such underlying oxygen barrier rubber layer is generally not intended to be exposed to the inner surface of the pneumatic tire cavity and is preferably exclusive of (e.g. preferably does not contain) a butyl rubber.

In a further aspect of the invention, a pneumatic tire is provided having an outer sidewall oxygen barrier rubber layer positioned as an outer surface of a tire sidewall to inhibit atmospheric oxygen from migrating to the remaining body of the tire.

Such sidewall oxygen barrier rubber layer contains a dispersion of an oxygen-adsorbing particulate activated carbon and may comprise, for example, elastomers comprised of a combination of cis 1,4-polyisoprene rubber and cis 1,4-polybutadiene rubber.

In another aspect of the invention, it may be desirable to protect the axial outer edges (belt edges in the shoulder region of the tire) of circumferential belt plies (cord reinforced belt plies positioned between the tire tread and tire carcass) by providing an oxygen barrier rubber layer which protectively covers (e.g. extends around the axial, outer edges of the belt ply) which might be referred to as a cap or boot of a gum rubber strip (gum rubber in a sense that the rubber composition does not contain woven cord reinforcement).

Accordingly, for another embodiment of this invention, a pneumatic tire is provided having a circumferential cord reinforced rubber belt ply layer which underlies the circumferential tread of the tire, wherein the axial edges of the belt ply layer are covered with an oxygen barrier rubber layer which contains a dispersion of oxygen-adsorbing particulate activated carbon. Such oxygen barrier rubber layer may be comprised of an elastomer comprised, for example, primarily of natural cis 1,4-polyisoprene rubber.

In a further aspect of the invention, the tire tread itself may be an enhanced oxygen barrier layer by being comprised of a rubber composition which contains a dispersion of oxygen-adsorbing particulate activated carbon to inhibit migration of atmospheric oxygen into the remainder of the tire.

Activated carbon, in general, can be a very versatile adsorbent for various gases and liquids in a sense that the size and density of its pores can be considerably varied.

Activated carbon can be, for example, a primarily amorphous particulate form of carbon, usually a microcrystalline, non-graphitic form of carbon, having a large surface area and pore volume which can make it useful in providing adsorptive properties for adsorbing various gases and liquids. For example, its average specific surface area (BET nitrogen adsorption) may be in a range of, for example, from about 500 to about 2000 m²/g or even greater. Such surface area is of a significant magnitude greater than the average nitrogen adsorption (BET) surface area in a range of, for example, from about 8 to about 150 m²/g for typical rubber reinforcing carbon blacks and therefore considered herein as being exclusive of such rubber reinforcing carbon blacks.

Commercial grades of activated carbon are often referred to as being gas-phase and liquid-phase adsorbents although the adsorbent abilities may somewhat overlap each other depending upon a particular activated carbon and intended gas and/or liquid to be adsorbed.

Generally, the larger the surface area of the activated carbon, the greater its adsorption capacity with the available surface area of the activated carbon being somewhat dependent upon its pore volume.

Therefore a large surface area may be promoted, for example, by:

(A) maximizing the number of pores of very small dimensions and/or

(B) minimizing the number of pores of very large dimensions.

The pores are often referred to in the sense of their sizes by the International Union of Pure and Applied Chemistry as “micropores”, “mesopores” and “macropores”.

Micropores are referred to as having a pore width of less than 1.8 nm, mesopores having a pore width of from 1.8 to 50 nm and macropores having a pore width of greater than 50 nm. The presence and pore size distribution of the micropores and mesopores is considered to contribute to the adsorptive capacity of the activated carbon. For example, a relatively high pore volume percentage of mesopores (e.g. at least 50 percent of the total pore volume having a pore width of about 1.8 to about 50 nm) is generally desirable.

Various raw materials may be used as a source for the carbon by carbonizing and then activation such as, for example and not intended to be limited, wood chips, sawdust, lignite, coconut shells, coal and carbon black refuse, to name a few sources.

Various methods of preparing activated carbon may be used. For example activated carbon may be prepared by one of two distinct processes, namely, by

(A) chemical activation, or

(B) thermal activation.

For example, thermal activation typically involves gasification of the carbon at relatively high temperatures, after an initial carbonization of the raw material. For example, chemical activation typically involves chemical dehydration/condensation reactions at significantly lower temperatures. For example, a carbonaceous material such as a lignocellulosic material may be treated with a chemical activation agent such as, for example, phosphoric acid or zinc chloride. Such lignocellulosic material may be, for example, wood chips and/or sawdust. Various method of preparing activated carbon are well known by those having skill in such art.

Various functional groups may be also formed, if desired, during activation of the carbon, for example by interaction of free radicals on the carbon surface, to render the surface of the activated carbon chemically reactive and to thereby further influence its adsorptive abilities and properties.

Activated carbon has been commercially manufactured and marketed for many years as adsorbents for various gasses and liquids (including for, example, use in gas masks and automobile gasoline recovery canisters as well as many other uses) and therefore are well known, as well as various methods of preparation, by those having skill in such art.

Representative examples of various activated carbon as well as applications and methods of preparation may be found, for example, in U.S. Pat. Nos. 5,206,207, 5,212,144, 5,250,491, 6,337,302, 6,863,713 and 6,696,384 (using carboxy methylcellulose post treatment) as well as earlier U.S. Pat. Nos. 2,083,303 and 2,508,474.

Representative of various commercially available activated carbons for various purposes are, for example, activated carbon from the MeadWestvaco company such as, for example, WV-A900, WV-A1100, WV-A1500, BAX950, BAX1100 and BAX1500; activated carbon from the Carbochem company such as, for example CARBOCHEM™ GS-75, GL80, VP-50, LP-30, DC-50, DC-40, LQ-900, LQ-1000, LQ900S, LQ-1240 and CA-10; activated carbon and activated carbon families from the Calgon Carbon Corporation as, for example, Ventsorb™, Vapor Pac™, Cal™, Cane Cal™, CPG™, Filtrasorb™, GW™, MRX™, and WPL-WPH™.

For this invention, it is desired that the activated carbon has a combination of surface area and pore size distribution suitable for adsorbing oxygen, the preparation and use of which is considered herein to be within the ability of a person skilled in the art of activated carbon preparation without undue experimentation.

It is considered herein that use of a dispersion of an oxygen-adsorbing activated carbon filler in an internal or external rubber component of a tire is novel and a significant departure from past practice.

For example, it is considered herein that the use of such oxygen-adsorbing rubber component as an internal rubber layer which underlies a butyl rubber based tire inner liner rubber layer, is novel and a significant departure from past practice.

For example, it is further considered herein that use of such oxygen-adsorbing rubber component as an internal rubber layer which covers the axial outer edges of a circumferential tire belt ply is novel and a significant departure from past practice.

In the description of this invention, the term “phr” is used to designate parts by weight of an ingredient per 100 parts of elastomer, including the butyl rubber, unless otherwise indicated. The terms “elastomer” and “rubber” are used interchangeably unless otherwise indicated. The terms “cure” and “vulcanize” are used interchangeably unless otherwise indicated.

### SUMMARY AND PRACTICE OF THE INVENTION

In accordance with this invention, a pneumatic tire is provided having a component comprised of an oxygen barrier rubber component (e.g. rubber layer) which contains a dispersion of oxygen-adsorbing particulate activated carbon (to inhibit migration of oxygen through such oxygen barrier rubber component).

Said component may be an internal or external component of the tire.

In one embodiment of the invention, the oxygen barrier component of the pneumatic tire is an external oxygen barrier rubber component comprised of at least one of an outer tire sidewall layer, tire chafer and tire tread (to inhibit migration of oxygen through such oxygen barrier component).

In another embodiment of the invention, the oxygen barrier component is an internal oxygen barrier rubber component selected from at least one of a tire tread base rubber layer underlying a tire outer tread rubber layer, rubber layer covering axial outer ends of a circumferential cord reinforced rubber belt ply, internal sidewall rubber layers, internal sidewall rubber apex components and internal sidewall rubber strengthening inserts (to inhibit migration of oxygen through such oxygen barrier component).

In a further embodiment of the invention, a pneumatic tire is provided having an internal oxygen barrier rubber layer positioned between a tire carcass ply and a tire inner liner rubber layer, wherein said oxygen barrier rubber layer is comprised of, for example, a cis 1,4-polyisoprene rubber and contains said dispersion of an oxygen-adsorbing particulate activated carbon.

In an additional embodiment of the invention, the inner liner rubber layer is comprised of at least one of butyl rubber and halobutyl rubber, wherein the halobutyl rubber may be comprised of, for example, at least one of bromobutyl rubber and chlorobutyl rubber.

In a further embodiment of the invention, the internal underlying oxygen barrier rubber layer underlying the tire inner liner rubber layer is exclusive of butyl rubber and halobutyl rubber.

In practice, the rubber inner liner air barrier rubber layer is preferably exclusive of the oxygen-adsorbing activated carbon contained in said internal underlying oxygen barrier rubber layer.

In an additional embodiment of the invention, a pneumatic tire is provided which contains a circumferential cord reinforced rubber belt ply layer which underlies the circumferential tread of said tire, wherein the axial edges of a said belt ply layer are covered by an oxygen-adsorbing component in a form of an oxygen-adsorbing rubber layer comprised of, for example, natural cis 1,4-polyisoprene rubber, and which contains a dispersion of an oxygen-adsorbing particulate activated carbon (to inhibit migration of oxygen through the oxygen-adsorbing rubber layer to the axial edges of the belt ply layer).

In a further embodiment of the invention a pneumatic tire is provided having an external, outer sidewall rubber layer containing a dispersion of an oxygen-adsorbing particulate activated carbon (to inhibit migration of atmospheric oxygen through the outer sidewall rubber layer).

In an additional embodiment of the invention, a pneumatic tire is provided having an outer tread rubber layer containing a running surface of the tread comprised of a rubber composition which contains a dispersion of an oxygen-adsorbing particulate activated carbon.

In a further embodiment of the invention, a pneumatic tire is provided having an tread base rubber layer underling a tread outer rubber layer (the tread outer rubber layer containing a running surface of the tread) wherein the tread base rubber layer is comprised of a rubber composition which contains a dispersion of an oxygen-adsorbing particulate activated carbon.

### DRAWINGS

The following drawings (FIG. 1, FIG. 1A and FIG. 1B) are provided for a further understanding of the invention.

In the drawings a partial cross-section of a pneumatic tire is provided to illustrate an internal oxygen barrier rubber layer positioned between a tire inner liner rubber layer and a tire carcass layer which is thereby underlying a tire inner liner.

In the drawings, the partial cross-section of the pneumatic tire is provided to illustrate a circumferential cord reinforced rubber belt ply layer having its axial (outer) edges covered an oxygen barrier rubber layer.

In FIG. 1 (together with FIG. 1-A and FIG. 1-B) the tire (1) is presented with a circumferential rubber tread (2), underlying circumferential tread base layer (3), underlying circumferential cord reinforced rubber belt ply layers (5), a rubber inner liner butyl rubber layer (9) and a cord reinforced rubber carcass ply (11).

In one embodiment, the tire contains an internal oxygen barrier layer (10) which is positioned between the inner liner rubber layer (9) and tire carcass ply layer (11).

The internal, oxygen barrier layer (10) is a diene-based rubber composition with the rubber being comprised primarily of natural cis 1,4-polyisoprene, which contains a dispersion of an oxygen-adsorbing particulate activated carbon to inhibit migration of oxygen through the oxygen barrier layer (10) to the remaining body of the tire such as for example to the carcass ply (11). The oxygen barrier rubber layer (10) also contains a dispersion of rubber reinforcing carbon black in addition to said oxygen-adsorbing activated carbon.

The inner liner butyl rubber layer (9) is comprised of a bromobutyl rubber based rubber composition which contains a dispersion of rubber reinforcing carbon black to the exclusion of the oxygen-adsorbing activated carbon of said internal, underlying oxygen barrier rubber layer (10).

In FIG. 1-A, an embodiment of the tire (1) is presented in which the belt ply layers (5) which underlie the tread base layer (3) are shown as a rubber composition (6) with internal cord reinforcement (4) together with a oxygen barrier gum rubber cap layer (7) covering its axial outer edges

The oxygen barrier rubber layer (7) is of a rubber composition comprised of natural cis 1,4-polyisoprene rubber and which contains a dispersion of an oxygen-adsorbing particulate activated carbon for adsorbing oxygen to thereby inhibit migration of oxygen through the oxygen barrier layer (7) to the axial outer edges of the belt ply layer (5).

FIG. 1-B is similar to FIG. 1-A except that a embodiment is presented in which a rubber wedge (8) is positioned between axial outer ends of first and second belt ply layers (5) which is a diene-based rubber composition comprised primarily of natural cis 1,4-polyisoprene, and which contains a dispersion of an oxygen-adsorbing particulate activated carbon for adsorbing oxygen to thereby inhibit migration of oxygen through the rubber wedge (8) to the belt ply layers (5).

In a further embodiment of the invention, the tire tread (2) which contains the tire tread running surface for contacting the ground and the underlying tire tread base (3) is comprised of a rubber composition containing at least one diene-based rubber and which contains a dispersion of an oxygen-adsorbing particulate activated carbon for adsorbing oxygen and thereby inhibiting migration of oxygen through the tread to the remaining body of the tire.

In an additional embodiment of the invention, an outer tire sidewall rubber layer (not shown) is composed of a rubber composition comprised of at least one diene-based rubber and which contains a dispersion of an oxygen-adsorbing particulate activated carbon for adsorbing oxygen and to thereby inhibit migration of oxygen through the outer tire sidewall rubber layer to the remaining body of the tire.

The following Examples are provided for a further understanding of the invention. The parts and percentages are by weight unless otherwise indicated.

### EXAMPLE I

Prospective exemplary illustrative oxygen barrier rubber compositions comprised of a natural rubber-based elastomer which contains a dispersion of oxygen-adsorbing particulate activated carbon are presented as Sample A and Sample B.

Prospective rubber Sample A is proposed for an oxygen barrier layer to be positioned next to and underlying a bromobutyl rubber based tire inner liner layer (between a tire carcass ply and tire inner liner layer) in a manner similar to the figures of the Drawings.

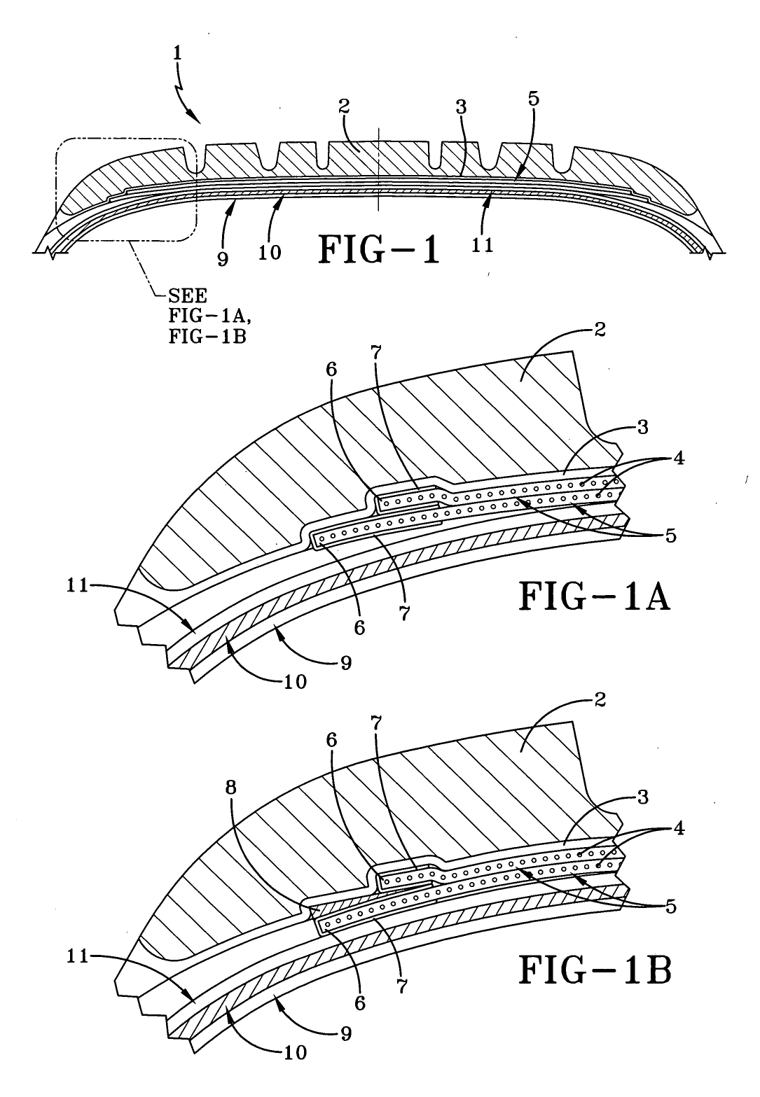

Prospective rubber Sample B is proposed for an oxygen barrier layer positioned to cover axial outer edges of a tire circumferential belt ply layer in a manner similar to FIG. 1-A of the Drawings or as a rubber wedge positioned between axial outer edges of two overlapping circumferential belt ply layers in a manner similar to FIG. 1-B of the Drawings.

The rubber compositions may be prepared by mixing ingredients in an internal rubber mixer(s).

The ingredients can be mixed in at least one sequential, non-productive (NP), mixing stage followed by a productive mixing stage (PR) in which curative(s) are added.

The proposed rubber Sample A and rubber Sample B are illustrated in the following Table 1. The parts and percentages are by weight unless otherwise indicated.

TABLE 1

| | | |
|---|---|---|
| | Barrier | Barrier |
| Material | Sample A | Sample B |

Non-Productive Mixing Step

| | | |
|---|---|---|
| Natural, cis 1,4-polyisoprene rubber | 100 | 100 |
| Rubber reinforcing carbon black, (N330)¹ | 50 | 50 |
| Zinc oxide | 8 | 8 |
| Fatty acid (primarily stearic acid) | 1 | 1 |
| Cobalt stearate | 0 | 2 |
| Oxygen-adsorbing activated carbon | 5 | 5 |

Productive Mixing Step

| | | |
|---|---|---|
| Sulfur | 3 | 4 |
| Sulfur vulcanization accelerator(s)² | 1.5 | 1.6 |

¹N330 rubber reinforcing carbon black, an ASTM designation
²Comprised of sulfenamide and quanidine types

The rubber Samples may be prepared by mixing the elastomers(s) together with reinforcing fillers and other rubber compounding ingredients in a non-productive mixing stage (NP) in an internal rubber mixer for a period of, for example, about 4 minutes to a temperature of, for example, about 160° C. The resulting rubber composition may then be mixed in a productive mixing stage (PR) in an internal rubber mixer with curatives for a period of, for example, about 2 minutes to a temperature of, for example, about 110° C. The rubber compositions can be sheeted out and cooled to below 40° C. between the non-productive mixing and the productive mixing steps.

### EXAMPLE II

A prospective exemplary illustrative tubeless pneumatic rubber tire can be prepared with an internal oxygen barrier rubber layer of rubber composition Sample A of Example I underlying its inner liner rubber in a manner similar to FIG. 1 and with an internal oxygen barrier layer of the rubber composition of Sample B of Example I covering the axial outer ends of its belt ply layer(s) in a manner similar to FIG. 1-A of the Drawings.

The green (uncured) tire can be cured in a suitable tire curing mold at a suitable temperature and time to form the vulcanized tire.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire having an oxygen barrier component comprised of an oxygen barrier rubber which contains a dispersion of oxygen-adsorbing particulate activated carbon.

2. The tire of claim 1 wherein said oxygen barrier component is an external oxygen barrier rubber component comprised of at least one of an outer tire sidewall layer, tire chafer and tire tread.

3. The tire of claim 1 wherein said oxygen barrier component is an internal oxygen barrier rubber component selected from at least one of a tire tread base rubber layer underlying a tire outer tread rubber layer, rubber layer covering axial outer ends of a circumferential cord reinforced rubber belt ply, internal sidewall rubber layers, internal sidewall rubber apex components and internal sidewall rubber strengthening inserts.

4. The tire of claim 1 wherein said oxygen barrier component is an internal oxygen barrier rubber layer positioned between a tire carcass ply and a tire inner liner rubber layer, wherein said oxygen barrier rubber layer is comprised of a cis 1,4-polyisoprene rubber and contains said dispersion of an oxygen-adsorbing particulate activated carbon.

5. The tire of claim 4 wherein said inner liner rubber layer is comprised of at least one of butyl rubber and halobutyl rubber.

6. The tire of claim 5 wherein said halobutyl rubber is selected from at least one of bromobutyl rubber and chlorobutyl rubber.

7. The tire of claim 4 wherein said internal underlying oxygen barrier rubber layer is exclusive of butyl rubber and halobutyl rubber.

8. The tire of claim 1 wherein said pneumatic tire contains a circumferential cord reinforced rubber belt ply layer which underlies the circumferential tread of said tire, wherein the axial edges of the said belt ply layer are covered by said oxygen-adsorbing component in a form of an oxygen-adsorbing rubber layer which contains a dispersion of an oxygen-adsorbing particulate activated carbon.

9. The tire of claim 8 wherein the rubber of said oxygen-adsorbing rubber layer is comprised of natural, cis 1,4-polyisoprene rubber.

10. The tire of claim 1 wherein said oxygen barrier component is a tire sidewall outer rubber layer.

11. The tire of claim 1 wherein said oxygen barrier component is an outer tire tread rubber layer containing a tread running surface.

12. The tire of claim 1 wherein said oxygen barrier component is a tread base rubber layer underlying an outer tread rubber layer, where said outer tread rubber layer contains a tread running surface.

13. The tire of claim 1 wherein said oxygen-adsorbing activated carbon is comprised of a microcrystalline, non-graphitic form of carbon having an average specific surface area determined by nitrogen adsorption of from about 500 to about 2000 m²/g and wherein at least 50 percent of the total pore volume of said oxygen-adsorbing activated carbon is comprised of pores having a pore width of from about 1.8 to about 50 nm.

14. The tire of claim 1 wherein said oxygen-adsorbing activated carbon is prepared by:
(A) chemical activation, or
(B) thermal activation.

15. The tire of claim 1 wherein said oxygen-adsorbing activated carbon is prepared by thermal activation wherein said thermal activation is comprised of gasifying carbon at high temperature after an initial carbonization.

16. The tire of claim 1 wherein said oxygen-adsorbing activated carbon is prepared by chemical activation comprised of at least one of chemical dehydration and condensation reaction.

17. The tire of claim 1 wherein said oxygen-adsorbing activated carbon is prepared by treating a lignocellulosic material with a chemical activation agent.

18. The tire of claim 1 wherein said oxygen-adsorbing activated carbon contains functional groups formed by activation of the carbon by interaction of free radicals on the carbon surface to render the surface of the activated carbon chemically reactive.

19. The tire of claim 1 wherein said oxygen-adsorbing activated carbon is post treated with carboxy methylcellulose.

20. The tire of claim 4 wherein said oxygen-adsorbing activated carbon is comprised of a microcrystalline, non-graphitic form of carbon having an average specific surface area determined by nitrogen adsorption of from about 500 to about 2000 m²/g and wherein at least 50 percent of the total pore volume of said oxygen-adsorbing activated carbon is comprised of pores having a pore width of from about 1.8 to about 50 nm.
